(19) United States
(12) Patent Application Publication
(10) Pub. No.: US 2002/0122947 A1
(43) Pub. Date: Sep. 5, 2002

(54) Coating composition comprising a reactive diluent

(76) Inventors: Keimpe Van Den Berg, Sassenheim (NL); Frederik Rous, Amsterdam (NL); Robert Paul Klaasen, Amsterdam (NL); Heert Andringa, Deventer (NL); Huig Klinkenberg, Katwijk aan Zee (NL); Berend Hoving, Lelystad (NL)

Correspondence Address: Lainie E. Parker, Akzo Nobel Inc., 7 Livingstone Avenue, Dobbs Ferry, NY, 10522-3408, US

(21) Appl. No.: 09/982,608

(22) Filed: Oct. 18, 2001

Related U.S. Application Data
(60) Provisional application No. 60/252,818, filed on Nov. 22, 2000.

(30) Foreign Application Priority Data
Oct. 25, 2000 (EP) 00203720.8

(51) Int. Cl. B32B 9/04; C08G 77/26

(52) U.S. Cl. 428/447; 525/73

(57) ABSTRACT

Coating composition comprising one or more compounds having functional groups which are reactive to olefinically unsaturated bonds, and a citraconimide functional compound, e.g., benzyl citraconimide, octyl citraconimide, or methoxy propyl citraconimide and/or an itaconimide functional compound as a reactive diluent. The reactive diluents are particularly suitable for use in oxidatively drying coating compositions, such as alkyd based coatings, or coating compositions which are curable by radical copolymerization.

This application claims priority based on European patent application No. 00203720.8, filed Oct. 25, 2000, and U.S. provisional patent application No. 60/252,818, filed Nov. 22, 2000.

### FIELD OF THE INVENTION

The invention relates to a coating composition comprising a reactive diluent, and to a reactive diluent for use in coating compositions. Reactive diluents are generally low molecular weight compounds showing low viscosity and act as solvents during formulation and processing of the coating. Unlike non-reactive solvents, reactive diluents can copolymerize with a resin. This way, emission of solvent on drying of the coating is prevented or at least reduced.

### BACKGROUND OF THE INVENTION

Reactive diluents for air drying coating compositions are known from WO 97/02229, WO 97/02230 and WO 97/02326. These diluents are rather difficult to synthesize and have plural reactive groups. Another example of a reactive diluent used in air drying compositions is cyclo pentadiene-modified linseed oil.

Known reactive diluents for coating compositions based on UV-initiated curing chemistry are for instance low viscous (meth)acrylic esters like tripropylene glycol diacrylate and hexane diol diacrylate. These type of reactive diluents are toxic, cause irritation and can only be used in an industrial environment.

### SUMMARY OF THE INVENTION

The object of the invention is to provide a coating composition, particularly one which is curable by oxidatively drying or by radical polymerization or charge transfer curing, comprising a reactive diluent capable of effectively reducing volatile organic content. A further object of the invention is a reactive diluent which is particularly suitable for oxidatively drying coating compositions or coating compositions curable by radically drying or charge transfer curing.

This object is achieved by a coating composition comprising a compound, preferably a binder, having functional groups which are reactive to olefinically unsaturated bonds, and one or more compounds according to the following formula

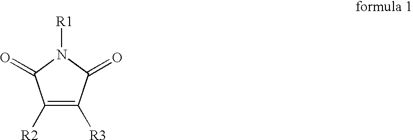

And/or one or more compounds according to the following formula 2;

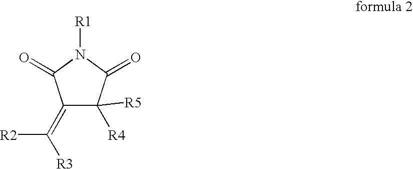

Or a mixture thereof, as a reactive diluent.

In formula 1, R1—R3 are hydrogen or substitute groups. Preferably, R1 is hydrogen, or an alkyl, hydroxyalkyl, carboxy alkyl, alkoxy silyl alkyl, alkoxy, alkenyl, or aryl group. Generally, R2 is a methyl group, but may alternatively be a larger group, such as an alkyl group, an alkoxy group or an aryl group. R3 is generally a hydrogen, but may alternatively be any suitable group, e.g. an alkyl group, such as methyl, if so desired.

In the compounds according to formula 2, R1—R5 are hydrogen or substitute groups. Preferably, R1, R2, and R3 are independently from each other selected from the group consisting of hydrogen, alkyl, alkoxy, hydroxy alkyl, carboxy alkyl, alkoxy silyl alkyl, alkenyl, or aryl groups. Generally, R4 and R5 are hydrogen, but alternatively either one of these or both may be any other suitable group, e.g., an alkyl group such as methyl.

### DETAILED DESCRIPTION OF THE INVENTION

It has been found that using the inventive reactive diluents in coating compositions, low volatile organic content can be obtained without negatively affecting properties such as viscosity, and without substantially affecting film properties. Further, these reactive diluents were found to be substantially odourless.

R1, R2, and R3 of the compound of formula 1 or R1—R5 of the compound of formula 2, may be chosen such as to obtain a desired molecular weight. Low molecular weights generally result in low viscosity. The molecular weight Mw is preferably between 80-800. Optimum molecular weight ranges from 100 to 400.

A suitable way for preparing compounds according to formula 1, is to prepare a citraconic anhydrid by reacting citraconic acid with acetic anhydride in the presence of a tertiary amine, a hindered secondary amine or a phosphine, followed by reacting the citraconic anhydride with an amine salt of acetic acid or propionic acid. Such a method is disclosed in EP-A 0 495 544.

Monofunctional citraconimides and itaconimides, i.e. compounds having only one citraconimide group or only one itaconimide group, are preferred for their low viscosity.

As a reactive diluent, the citraconimide or itaconimide functional compounds must in general be liquid at room temperature. Preferably, the viscosity of these compounds is below 0,15 Pa.s at 23° C. Best diluting is obtained when the compounds have a viscosity below 0,1 Pa.s at 23° C.

Suitable examples of reactive diluents according to the invention are N-benzyl citraconimide, N-octyl citraconimide, N-(2-hydroxyethyl) citraconimide, and N-(3-methoxy propyl) citraconimide.

The coating composition according to the present invention may be based on any suitable crosslinking chemistry. The binder comprises functional groups for crosslinking which may for example be hydroxy groups, alkoxy silane, isocyanate carboxyl, and/or epoxy groups. Oxidatively drying compositions, such as alkyd based compositions, or radically curing systems are preferred.

Alkyd resins suitable for use in a coating composition according to the invention can be prepared from unsaturated and saturated fatty acids, polycarboxylic acids, and di- or polyvalent hydroxyl compounds. The number of unsaturated fatty acids eligible for use in the preparation of the alkyd resins to be employed according to the invention is large. Preference is given to the use of mono- and polyunsaturated fatty acids, preferably those containing 12 to 26 carbon atoms. Specific examples are mono-unsaturated fatty acids, such as lauroleic acid, myristoleic acid, palmitoleic acid, oleic acid, gadoleic acid, erucic acid, ricinoleic acid; bi-unsaturated fatty acids, such as linoleic acid; tri-unsaturated acids, such as linolenic acid, eleostearic acid, and licanic acid; quadri-unsaturated fatty acids, such as arachidonic acid and clupanodonic acid, and other unsaturated fatty acids obtained from animal or vegetable oils. The number of saturated fatty acids is also large. Preference is given to the use of saturated fatty acids containing 12 to 26 carbon atoms. Specific examples include lauric acid, myristic acid, palmitic acid, stearic acid, and arachidic acid. Other monocarboxylic acids suitable for use include tetrahydrobenzoic acid and hydrogenated or non-hydrogenated abietic acid or its isomer. If so desired, the monocarboxylic acids in question may be used wholly or in part as triglyceride, e.g., as vegetable oil, in the preparation of the alkyd resin. If so desired, mixtures of two or more of such monocarboxylic acids or triglycerides may be employed, optionally in the presence of one or more saturated, (cyclo)aliphatic or aromatic monocarboxylic acids, e.g., pivalic acid, 2-ethylhexanoic acid, lauric acid, palmitic acid, stearic acid, 4-tert.butyl-benzoic acid, cyclopentane carboxylic acid, naphthenic acid, cyclohexane carboxylic acid, 2,4-dimethyl benzoic acid, 2-methyl benzoic acid, and benzoic acid.

Examples of polycarboxylic acids include phthalic acid, isophthalic acid, terephthalic acid, 5-tert. butyl isophthalic acid, trimellitic acid, pyromellitic acid, succinic acid, adipic acid, 2,2,4-trimethyl adipic acid, azelaic acid, sebacic acid, dimerised fatty acids, cyclopentane-1,2-dicarboxylic acid, cyclohexane-1,2-dicarboxylic acid, 4-methylcyclohexane-1,2-dicarboxylic acid, tetrahydrophthalic acid, endomethylene-cyclohexane-1,2-dicarboxylic acid, butane-1,2,3,4-tetracarboxylic acid, endoisopropylidene-cyclohexane-1,2-dicarboxylic acid, cyclohexane-1,2,4,5-tetracarboxylic acid, and butane-1,2,3,4-tetracarboxylic acid. If so desired, the carboxylic acids in question may be used as anhydrides or in the form of an ester, e.g., an ester of an alcohol having 1-4 carbon atoms.

In addition, the alkyd resin comprises di- or polyvalent hydroxyl compounds. Examples of suitable divalent hydroxyl compounds are ethylene glycol, 1,3-propane diol, 1,6-hexane diol, 1,12-dodecane diol, 3-methyl-1,5-pentane diol, 2,2,4-trimethyl-1,6-hexane diol, 2,2-dimethyl-1,3-propane diol, and 2-methyl-2-cyclohexyl-1,3-propane diol. Examples of suitable triols are glycerol, trimethylol ethane, and trimethylol propane. Suitable polyols having more than 3 hydroxyl groups are pentaerythritol, sorbitol, and etherification products of the compounds in question, such as ditrimethylol propane and di-, tri-, and tetrapentaerythritol. Preferably, use is made of compounds having 3-12 carbon atoms, e.g., trimethylol propane and pentaerythritol.

The alkyd resins can be obtained by direct esterification of the constituent components, with the option of a portion of these components having been converted already into ester diols or polyester diols. Alternatively, the unsaturated fatty acids can be added in the form of a drying oil, such as sunflower oil, linseed oil, tuna fish oil, dehydrated castor oil, coconut oil, and dehydrated coconut oil. Transesterification with the other added acids and diols will then give the final alkyd resin. This transesterification generally takes place at a temperature in the range of 115 to 250° C., optionally with solvents such as toluene and/or xylene also present. The reaction generally is carried out in the presence of a catalytic amount of a transesterification catalyst.

Examples of transesterification catalysts suitable for use include acids such as p-toluene sulphonic acid, a basic compound such as an amine, or compounds such as calcium oxide, zinc oxide, tetraisopropyl orthotitanate, dibutyl tin oxide, and triphenyl benzyl phosphonium chloride.

The number average molecular weight of the alkyd resin thus prepared preferably is at least 1000, preferably from 2000 to 5000.

Alternatively, the coating composition may comprise a binder system which is curable by radical copolymerization, for instance initiated by irradiation of UV-light. Suitable examples of such a binder system are (meth)acryloyl-functional binders, such as acryloyl functional polyurethanes. Such (meth)acryloyl groups-containing polyurethanes can be prepared using conventional methods of polyurethane synthesis by conversion of polyisocyanates with hydroxyalkyl (meth)acrylates and a chain extender if desired. Suitable chain extenders include diols, polyols, dithiols, polythiols, diamines, and polyamines.

The coating composition according to the invention may furthermore contain various additives such as pigments, fillers, siccatives, anti-skinning agents, dispersants, surfactants, inhibitors, fillers, anti-static agents, flame-retardant agents, lubricants, anti-foaming agents, cosolvents, extenders, film formation aids, plasticizers, anti-oxidants, anti-freezing agents, waxes, preservatives, thickeners, thixotropic agents, etc.

The composition according to the invention is suitable for various industrial applications, e.g., automotive or car repair field, or in decorative applications, e.g. in the do-it-yourself market or in the professional market. Coating compositions according to the invention can be used for coating precoated or uncoated substrates of wood, metal, plastics, ceramics, concrete, etc.

The coating composition may be water-borne, in order to further reduce the volatile organic content. However, the reactive diluents are also suitable for use in solvent-borne coatings, preferably in so-called high-solids coatings having a solids content of at least 60% by weight of the composition.

The coating composition according to the present invention can be applied by conventional methods, including brushing, roll coating, spray coating, or dipping.

The invention is further illustrated by the following examples.

In Examples 1 and 2 and Comparative Example A, viscosity was measured in a DIN flow cup number 4 in accordance with DIN 53221-1987. The viscosity is given in seconds. In Examples 3 and 4 and Comparative Examples A and B, viscosity was measured using a Brookfield Cap 2000 at a temperature of 23° C. and a shear of 10000 s⁻¹.

The VOC of the coating composition was calculated as the weight ratio of the non-reactive solvents content to the total solids content. The total solids content includes the content of reactive diluents, but not water.

Drying was tested by means of a BK Drying Recorder. The results obtained in this fashion can be classified as follows:

Phase 1 :the line traced by the pin closes up again (“open time”).

Phase 2 :the pin traces a scratchy line (“dust free”).

Phase 3 :the pin traces a straight line in the paint which does not close up again (“tack-free time”).

In the examples the following commercial names are used:

| | |
|---|---|
| Autowave ® | water-borne base coat, available from Akzo |
| | Nobel; |
| Byk ® 346 | wetting agent, available from Byk; |
| Darocure ® 1173 | 2-hydroxy-2-methyl-1-phenyl propane-1-one, a |
| | photoinitiator available from Ciba; |
| Desmodur ® W | polyisocyanate, available from Bayer; |
| Dilulin ® | reactive diluent, cyclopentadiene-modified |
| | linseed oil. Available from Croda Resins; |
| Eponex ® 1510 | hydrogenated bisphenol-A diglycidyl ether, |
| | available from Shell; |
| Kronos ® 2310 | TiO₂ (rutile) based pigment, available from |
| | Kronos; |
| Nuodex ® Combi APR | a siccative comprising cobalt, zirconium and |
| | calcium, commercially available from Servo |
| | Delden BV, Delden, the Netherlands; |
| Shellsol ® D40 | non-reactive aliphatic diluent, available from |
| | Shell. |

All contents are given in grams, unless indicated otherwise.

The citraconimide functional compounds used in the examples, were prepared according to the method of EP-A 0 495 544. As a result of this method, the citraconimide compound generally comprises some percentages (typically about 5 wt. %) of the corresponding itaconimide functional compound.

### COMPARATIVE EXAMPLE A AND EXAMPLE 1

In Comparative Example A and Example 1, a UV curable solvent-borne coating composition was prepared based on an acryloyl functional polyurethane resin.

The acryloyl-functional polyurethane was prepared in the following three steps a, b, and c:

a) Preparation of a polyester comprising polyethylene oxide groups

A 3 l 4-neck flask fitted with a variable speed stirrer, thermocouples in combination with a controller, a distillation column, a reflux condenser, a nitrogen sparge, and a heating mantle was charged with a mixture composed of 332 g of hexahydrophthalic anhydride and 1614 g of polyethylene glycol monomethyl ether of an average molecular weight of 750. The mixture was heated to 170° C. for 30 minutes, cooled to 140° C., and 269 g of di(trimethylolpropane) were added, followed by 132 g of xylene and 3.3 g of a 85% aqueous phosphoric acid solution. The mixture was heated to 235° C. and water was azeotropically distilled off until the acid value of the reaction mixture was below 5 mg KOH/g. The mixture was then cooled to 180° C. and xylene was distilled off at reduced pressure. The resulting polyester diol solidified at room temperature and had an acid value of 3.9 mg KOH/g and a hydroxyl value of 59 mg KOH/g.

b) Preparation of an acryloyl-functional diol

A 2-litre 4-neck flask, which was fitted with a variable speed stirrer, a thermocouple, a dry air sparge via the head space, a dip tube, and a heating mantle, was charged with 573 g of Eponex®1510, 17.5 g of acrylic acid, and 0.56 g of 2,6-ditert. butyl p-cresol. The mixture was heated to 95° C. while bubbling with dry air. A mixture of 157.7 g of acrylic acid, 0.56 g of 2,6-ditert. butyl p-cresol, and 0.75 g of chromium 2-ethylhexanoate was added dropwise in approximately 3 hours. The temperature of the reaction mixture was maintained between 95 and 100° C. Stirring at this temperature was continued until the acid value of the reaction mixture had dropped below 5 mg KOH/g. The prepared adduct was cooled and diluted with 97 g of dry 2-butanone.

c) Preparation of an Acryloyl-functional Polyurethane Resin Comprising Polyethylene Oxide Groups

A 3 l 4-neck flask fitted with a variable speed stirrer, thermocouples in combination with a controller, a condenser, a dry air sparge, and a heating mantle was charged with a mixture composed of 273.2 g of acryloyl-functional diol b), 146.7 g of polyester a), 12.26 g of trimethylol propane, 99.1 g of 4-hydroxybutyl acrylate, 260.8 g of Desmodur® W, 1.50 g of 2,6-ditert. butyl-p-cresol, and 250 g of 2-butanone. The mixture was heated to 45° C. and stirred until homogeneous, while bubbling with dry air. Then 0.94 g of tin(ll) octanoate was added after one hour of stirring. The reaction mixture was stirred for approximately six hours at 80° C. until the isocyanate content was <0.1 wt. %. After that, 3 ml of ethanol 100% was added and stirring was continued for about 30 minutes. The reaction mixture was cooled to 45° C. and subsequently diluted with 72 g of 2-butanone. A resin with the following characteristics was obtained: Solids content 68%, Mn 2686, Mw 11153.

The obtained polyurethane was used to prepare a solvent borne coating composition without a reactive diluent (Comparative Example A) and a similar coating composition with octyl citraconimide as a reactive diluent (Example 1). Contents of the compositions are given in Table 1.

TABLE 1

| Compar- | |
|---|---|
| ative | |
| Example | Example |
| A | 1 |

| | | | | |
|---|---|---|---|---|
| Polyurethane resin | 80.0 | g | 80.0 | g |
| Butylglycol | 5.0 | g | 1.7 | g |
| Butylacetate | 40.0 | g | 37 | g |
| Methylethylketone | 15.0 | g | 8 | g |
| Darocure ® 1173 | 2.2 | g | 2.2 | g |

| | | | |
|---|---|---|---|
| N-octyl citraconimide | — | 25.8 | g |

Viscosity was measured in a Din cup 4. For both compositions measured viscosity was 19 seconds. VOC was 565 g/l in Comparative Example A, but considerably lower, 412 g/l, in Example 1.

Both formulations were sprayed over steel panels. One minute after application the panels were irradiated under Cleo® fluorescent lamps (ex Philips) at an UV intensity of 6 mW/cm². After 5 minutes irradiation both panels were dry to handle.

### EXAMPLE 2

An acryloyl-functional polyurethane resin was prepared as in Example 1, with the difference that the reaction mixture was diluted with 154 g of 2-butanone. The speed of the stirrer was increased, and 1125 g of water was added at a rate of 12 ml/min. After all of the water had been added a distillation head and a vacuum pump were connected to the flask and the pressure was gradually lowered until all 2-butanone was distilled off. A white emulsion was obtained having a solids content of 44% by weight.

An aqueous coating composition was prepared using the contents given in Table 2.

TABLE 2

Example 2

| | | |
|---|---|---|
| Polyurethane emulsion | 20.0 | g |
| Water | 3.0 | g |
| Butylglycol | 1.0 | g |
| Byk ® 346 | 0.1 | g |
| N-3-methoxypropyl | 2.92 | g |
| citraconimide | | |
| Darocure ® 1173 | 0.51 | g |

Volatile organic content was calculated as 100 g/l.

The formulation was applied on a tin plate and on a blue metallic water borne base coat (Autowave®). The film had a dry layer thickness of 74 μm. The panels were dried until all the water had evaporated (at least 90 minutes at room temperature or 30 minutes at 60° C.). One minute after application, the film was irradiated for 10 minutes at room temperature under Cleo® fluorescent lamps (ex Philips) at an UV intensity of 6 mW/cm². After one day, the film had a Persoz hardness of 171 s. After seven days, Persoz hardness was 175 s. Resistance to methyl ethyl ketone, tested by a one minute exposure, was 4 on a scale from 0 (completely dissolved) to 5 (no damage). Water resistance, tested by a one hour exposure, was 5 on the same scale.

### EXAMPLE 3 AND 4; COMPARATIVE EXAMPLES B AND C

A high solids alkyd resin was used based on sunflower fatty acid and ricinic fatty acid. Oil content was 73% by weight. Viscosity was 11,8 Pa.s at a solids content of 90% in Shellsol® D40.

In Comparative Example B, a composition was made based on this alkyd and further comprising titanium dioxide, a siccative, and an anti-skinning agent. A non-reactive solvent was added to obtain a viscosity of 0,6 Pa.s. VOC was calculated as 270 g/l.

In Comparative Example C, 45 pbw of a prior art reactive diluent (Dilulin®) was used, to obtain a composition with the same viscosity as in Comparative Example B. To obtain a composition with the same viscosity, VOC, and solids content as in Comparative Example C, only 30 pbw of N-octyl citraconimide was needed in Example 3, while only 30 pbw of N-benzyl citraconimide was needed in Example 4.

TABLE 3

| | Composition contents | | | Solids |
|---|---|---|---|---|
| | in parts by weight | Viscosity | VOC | Content |
| | (pbw) | (Pa.s) | (g/l) | (weight %) |
| Comparative | 72 pbw-Kronos ® 2310 | 0,6 | 270 | 78 |
| Example B | 100 pbw-Alkyd (solids | | | |
| | resin) | | | |
| | 7,5 pbw-Nuodex | | | |
| | Combi ® APB | | | |
| | 0,54 pbw- | | | |
| | Methylethylketoxime | | | |
| | 22 pbw-Shellsol ® D40 | | | |
| Comparative | 72 pbw-Kronos ® 2310 | 0.6 | 135 | 90 |
| Example C | 55 pbw-Alkyd (solids | | | |
| | resin) | | | |
| | 45 pbw-Dilulin ® | | | |
| | 7,5 pbw-Nuodex | | | |
| | Combi ® APB | | | |
| | 0,54 pbw- | | | |
| | Methylethylketoxime | | | |
| | 10 pbw-Shellsol ® D40 | | | |
| Example 3 | 72 pbw-Kronos ® 2310 | 0.6 | 135 | 90 |
| | 70 pbw-Alkyd (solids | | | |
| | resin) | | | |
| | 30 pbw-N-Octyl | | | |
| | citraconimide | | | |
| | 7,5 pbw-Nuodex | | | |
| | Combi ® APB | | | |
| | 0,54 pbw- | | | |
| | Methylethylketoxime | | | |
| | 10 pbw-Shellsol ® D40 | | | |
| Example 4 | 72 pbw-Kronos ® 2310 | 0.6 | 135 | 90 |
| | 70 pbw-Alkyd (solids | | | |
| | resin) | | | |
| | 30 pbw-N-Benzyl | | | |
| | citraconimide | | | |
| | 7,5 pbw-Nuodex | | | |
| | Combi ® APB | | | |
| | 0,54 pbw- | | | |
| | Methylethylketoxime | | | |
| | pbw-Shellsol ® D40 | | | |

After preparation, samples of the compositions were applied with a 90 μm drawbar on a glass substrate. Curing took place at 10° C. and 80% relative humidity in a climatised room. Drying was measured as indicated above. Results are given in Table 4.

TABLE 4

| | Phase 1 | Phase 2 | Phase 3 |
|---|---|---|---|
| | (hours) | (hours) | (hours) |
| Comparative | 1,75 | 1,75 | 6,5 |
| Example B | | | |
| Comparative | 3,5 | 3,5 | 11 |
| Example C | | | |
| Example 3 | 4 | 5 | 5 |
| Example 4 | 3,75 | 3,75 | 6,5 |

Whereas the results for Phase 1 and Phase 2 in Examples 3 and 4 were comparable with the results in Comparative Example C, the tack free time (Phase 3) was considerably better with Examples 3 and 4.

1. Coating composition comprising one or more compounds having functional groups which are reactive to olefinically unsaturated bonds, and one or more reactive diluents, at least one of the reactive diluents being a compound according to the following formula 1: 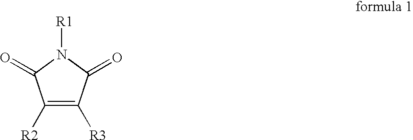
Or a compound according to the following formula 2: 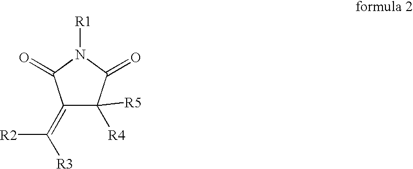
Or a mixture thereof.

2. Coating composition according to claim 1, wherein the compound according to formula 1 is substituted at the nitrogen atom by an alkyl, alkoxy, hydroxy alkyl, carboxy alkyl, alkoxy silyl alkyl, alkenyl, or aryl group.

3. Coating composition according to claim 2, wherein the compound according to formula 1 is benzyl citraconimide, octyl citraconimide, or methoxy propyl citraconimide.

4. Coating composition according to claim 1, wherein the coating composition comprises an alkyd.

5. Coating composition according to claim 1, wherein the coating composition comprises a binder system which is curable by radical copolymerization.

6. Coating composition according to claim 1, wherein the coating composition is water-borne.

7. Coating composition according to claim 1, wherein the composition is solvent-borne.

8. Coating composition according to claim 1, wherein the composition is solvent-borne and has a solids content of at least 60% by weight of the composition.

9. Coating composition according to claim 1, wherein the composition is free of the combination of methoxy propyl citraconimide, polythiols and one or more compounds selected from the group consisting of primary or secondary amines, aldimines, ketimines, enamines, and oxazolidines.

10. Use of a compound according to formula 1 or 2 of claim 1 as a reactive diluent for a coating composition.

11. A substrate coated with the coating composition of claim 1.

12. Reactive diluent for a coating composition curable by oxidatively drying or by radical polymerisation, the reactive diluent being a compound according to [chemical structure]
